(19) United States
(12) Patent Application Publication
(10) Pub. No.: US 2020/0014160 A1
(43) Pub. Date: Jan. 9, 2020

(54) SIZE ADJUSTABLE CHARGER

(71) Applicant: Thin Energy Ltd., Ashkelon (IL)

(72) Inventors: Daniel ASSIS, Elquan (IL); Itay HASID, Tel Aviv (IL)

(73) Assignee: Thin Energy Ltd., Ashkelon (IL)

(21) Appl. No.: 16/470,253

(22) PCT Filed: Dec. 14, 2017
(86) PCT No.: PCT/IL2017/051350

§ 371 Date: Jun. 17, 2019

(30) Foreign Application Priority Data
Dec. 15, 2016 (IL) 249609

(51) Int. Cl. H01R 31/06; H01R 13/50; H01R 13/66; H01R 24/68; H01R 24/62; H02J 7/00; H02J 7/02

(52) U.S. Cl. CPC H01R 31/065; H01R 13/501; H01R 13/6675; H01R 2103/00; H01R 24/62; H02J 7/0045; H02J 7/02; H01R 24/68

(57) ABSTRACT

A size adjustable charger that is connectable to an outlet in order to charge a battery powered device, such as a mobile electronic device is disclosed. The charger may comprise at least a first and a second charger body sections, and one or more force transmitting elements, such as, one or more hinges, configured to be interconnected between the at least first and second charger body sections and to facilitate a size adjustment operation. The size adjustable charges may further include a set of outlet-connectable prongs. The prongs may be insertable to an outlet or socket in a first position of the outlet-connectable prongs or in a first relative position of the at least first and second charger body sections, and non-insertable to an outlet in a second position of the outlet-connectable prongs or in a first relative position of the at least first and second charger body sections.

### FIELD OF THE INVENTION

The present invention relates to the field of electrical devices. More particularly, the invention relates to a size adjustable charger.

### BACKGROUND OF THE INVENTION

Due to the ubiquitousness and continuous use of mobile electronic devices such as tablets, portable computers and mobile phones, users are dismayed to find that the battery capacity of these mobile devices is very limited. Consequently the mobile devices need to be charged at least once a day, generally by means of a charger connected to AC power.

A mobile device charger having a large size as a result of its internal transformer and many windings often covers more than one socket when connected in an outlet to AC power, causing much aggravation when it is desired to operate another electrical or electronic device that also has to be connected to AC power but cannot due the lack of an available outlet.

Another disadvantage of a large sized charger is its bulkiness. A user often chooses not to carry a charger when traveling due to the relatively large volume it occupies, and is disappointed when the battery becomes uncharged and the mobile device cannot be used.

Using a miniature sized charger, in particular slim sized charger, may overcome the above disadvantages. However, when wishing to implement a slim charger, in some configurations, it might be impossible to realize the active and the natural prongs according to the required standards, as in many standard plug/socket systems the distance between the active and the natural prongs should be about 12 mm-16 mm. Due to its slime form, such distance requirement might not be achieved when the thickness of the charger is less than 10 mm (as there is not enough gap to properly place the prongs with respect to the standards).

Therefore, a novel solution in the configuration of such slim chargers is needed in order to provide a slim charger product according to such standard requirements.

It is an object of the present invention to provide a size adjustable charger whose operability is not compromised when its size is adjusted.

It is an additional object of the present invention to provide a size adjustable charger that is connectable to an AC outlet both before and after a size adjustment.

Other objects and advantages of the invention will become apparent as the description proceeds.

### SUMMARY OF THE INVENTION

The present invention provides a size adjustable AC-DC charger, comprising first and second charger body sections, and one or more force transmitting elements configured to be interconnected between said first and second charger body sections and to transmit a disposition changing force to said second charger body section after being applied to said first charger body section to facilitate a size adjustment operation, wherein said charger is operable to charge a battery powered device when said second charger body section is positioned at both a first disposition prior to said size adjustment operation and at a second disposition following said size adjustment operation.

The size adjustable charger has significant utility when its thickness in an opened condition is less than 1 cm, for example equal to or less than 3 mm.

The charger comprises a first circuit connectable to a source of AC power and housed within the first body section, a second circuit connectable to, and in charging relation with, the battery powered device and housed within the second body section, and a flexible cable extending between said first circuit and said second circuit to maintain current flow therebetween despite a change in disposition of the second charger body section. The flexible cable preferably passes through an internal charger region that is devoid of circuitry and through a continuous and common portion of the first and second body sections.

In one embodiment, the charger is foldable between an opened condition and a closed condition.

In one aspect, the charger further comprises a set of outlet-connectable prongs that are inaccessible or inoperatively connectable to an outlet when the charger is set to the opened condition and that are accessible and operatively connectable to the outlet when the charger is set to the closed condition.

In one aspect, each of the first and second charger body sections is formed with a recess coinciding with a corresponding inner face thereof and with a prong bearing block which is fixed within said recess configured such that one of the prongs extends lengthwise from said block and is inaccessibly received within the recess of the other charger body section when the charger is set to the opened condition, yet protrudes from the corresponding inner face when the charger is set to the closed condition.

In one aspect, the prongs are pivotable so as to be accessible to the outlet in a first pivoted position and to be inaccessible to the outlet in a second pivoted position.

In one aspect, each of the prongs is positioned on an inner face of the charger and is inaccessible to the outlet when the charger is set to the opened condition.

In one aspect, each of the prongs is positioned on an upper or lower face of the charger and is inoperatively connectable to the outlet when the charger is set to the opened condition due to spacing between the prongs which is greater than spacing between slots of the outlet.

### BRIEF DESCRIPTION OF THE DRAWINGS

In the drawings:

FIG. 1 is a block diagram of the electrical layout of a size adjustable charger according to one embodiment of the invention;

FIG. 2 is a perspective view from the bottom of a size adjustable charger, shown in an opened condition, according to one embodiment of the invention;

FIG. 3 is a perspective view from the top of the size adjustable charger of FIG. 2, shown in an opened condition;

FIG. 4 is a perspective view from the top of the size adjustable charger of FIG. 2, shown in a partially inwardly folded condition;

FIG. 5 is a perspective view from the top and side of the size adjustable charger of FIG. 2, shown in a partially inwardly folded condition;

FIG. 6 is a perspective view from the top of the size adjustable charger of FIG. 2, shown in a closed condition;

FIG. 7 is a perspective view from the inner side of the size adjustable charger of FIG. 2, shown in a closed condition;

FIG. 8 is a perspective view from the top and inner side of a size adjustable charger according to another embodiment of the invention, shown in a closed condition while the prongs are unpivoted;

FIG. 9 is a perspective view from the top and inner side of the size adjustable charger of FIG. 8, shown in a closed condition while the prongs are pivoted; and

FIG. 10 is a perspective view from the top and front of a size adjustable charger according to another embodiment of the invention, shown in a closed condition while the prongs are pivoted.

### DETAILED DESCRIPTION OF PREFERRED EMBODIMENTS

The present invention is a size adjustable AC-DC charger that is connectable to an AC outlet in order to charge a battery powered device, such as a mobile electronic device, both before and after a size adjustment.

The charger of the present invention may be thin, generally thinner than 1 cm, for example a thickness ranging from 4-7 mm, and may even have a thickness equal to or less than 3 mm, for example 2 or 2.5 mm, in order to be conveniently carried in one's wallet or shirt pocket and to ensure that the charger will always be available for charging a mobile electronic device, when necessary. Despite its thinness, the unreduced charger has a substantial surface area that generally covers two separate sockets of an outlet when prongs of the charger, e.g. pins, blades or other types of connectors, are connected to corresponding slots of one of the sockets of the outlet. When the charger is size reduced, as will be described hereinafter, only one of the sockets will be covered by the charger, advantageously allowing another electrical or electronic device to be connected simultaneously to AC power.

The thinness of the charger is made possible for example by converting AC power to DC power in two stages, as described in copending IL 247353 by the same applicant. In a first stage, the high voltage of AC power received from the electrical grid is converted to an intermediate non-isolated voltage level by means of a rectifier and a DC-DC voltage converter. In a second stage, a transformer is used to convert the non-isolated intermediate DC voltage to isolated low DC voltage that is suitable for charging the mobile electronic device. By virtue of the voltage conversion to an intermediate non-isolated voltage level in the first stage, miniature components, such as inductors and/or capacitors, are able to replace the physically large transformers typically used in prior art charger circuits. Although a transformer is used in the second stage, conversion from intermediate-level voltage to low-level voltage advantageously requires less inductance, and therefore less transformer windings and a significantly smaller transformer core, than the large sized transformer that is needed to convert high AC voltage to low DC voltage according to the prior art.

It will be appreciated that a thin charger may be configured in other ways as well in conjunction with dedicated electronic or electric circuits.

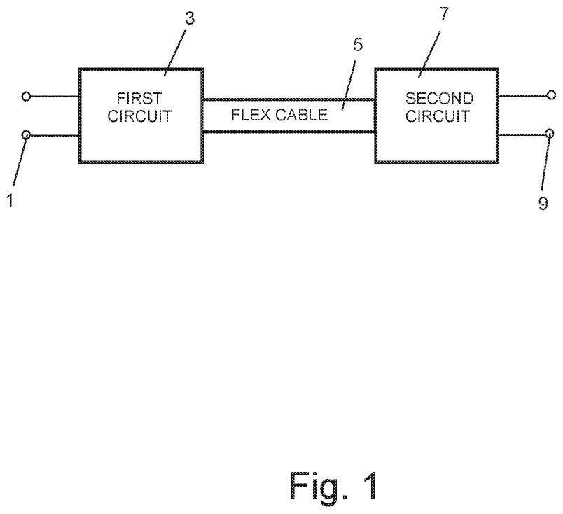

Reference is first made to FIG. 1, which schematically illustrates the electrical layout of the charger which facilitates a size adjustment operation. Charger 10 comprises a first circuit 3 connected to input terminals 1 adapted to receive AC power from the electrical grid, generally by means of prongs connectable to an outlet, and a second circuit 7 connected to output terminals 9 for connection to a mobile electronic device. First circuit 3 supports a first electrical function, such as conversion of high-voltage AC power to an intermediate non-isolated voltage level, and second circuit 7 supports a second electrical function, such as conversion of non-isolated intermediate DC voltage to isolated low DC voltage, generally comprising a filter circuit. A flexible cable 5, located partially or completely at a region that is devoid of circuitry, extends between first circuit 3 and second circuit 7 to maintain current flow therebetween despite a change in disposition of two corresponding regions of charger 10.

It will be appreciated that charger 10 may comprise more than two interconnected circuits as well.

Accordingly, charger 10 is able to undergo many size adjustment operations selected from, but not limited to, a sliding operation, a folding operation and an extension/retraction operation without compromising the ability to charge the mobile device.

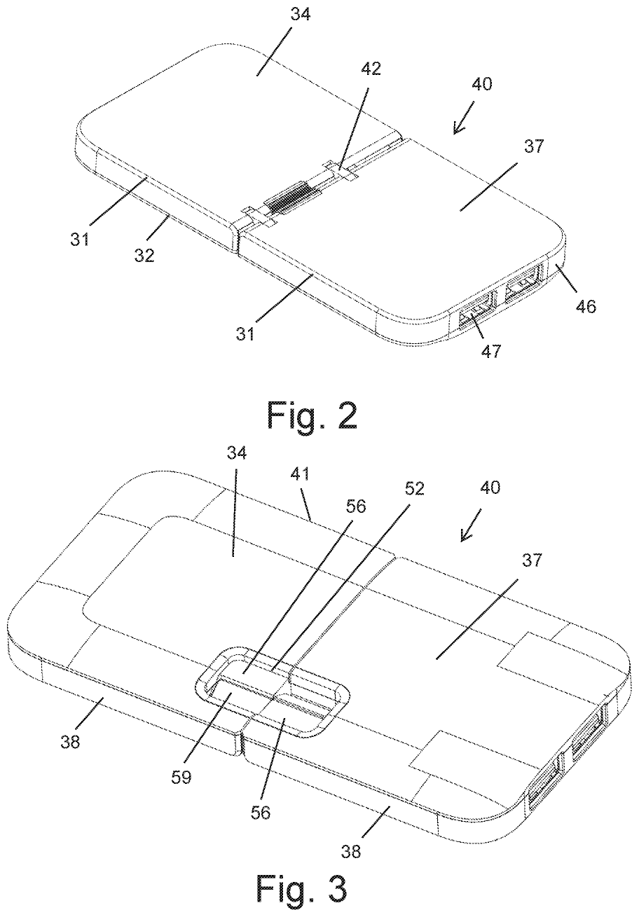

Embodiments of a foldable charger are illustrated in FIGS. 2-10. When a charger is folded to a closed condition, its length is significantly reduced to such a degree that, advantageously, only one socket of an outlet will be covered by the charger during a charging operation, as opposed to two or more when the prongs of a prior art charger are plugged into the outlet.

At times, the charger is unable to be connected to an outlet if it were not folded. As previously described, the charger may be significantly thin, for example on the order of 3 mm in order to be conveniently carried in the pocket of a wallet and to thereby increase charger availability. Two prongs are unable to be secured to a wall of the charger in side by side relation due to this thinness. However when the charger is folded, two separate prongs may be brought together at a spacing equal to that of the slots of a socket to facilitate the charging operation.

FIG. 2 illustrates a bottom view of foldable charger 40 in an opened condition, according to one embodiment of the present invention, exposing the bottom face 31 of first charger body section 34 and second charger body section 37 and concealing their upper face 32. Charger 40 is shown to be rectangular, but any other configuration is also in the scope of the invention.

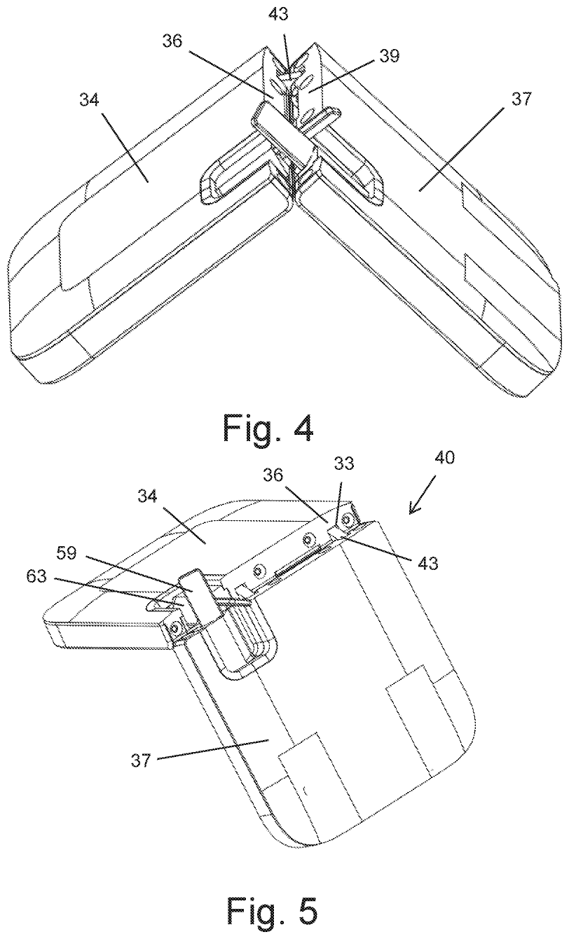

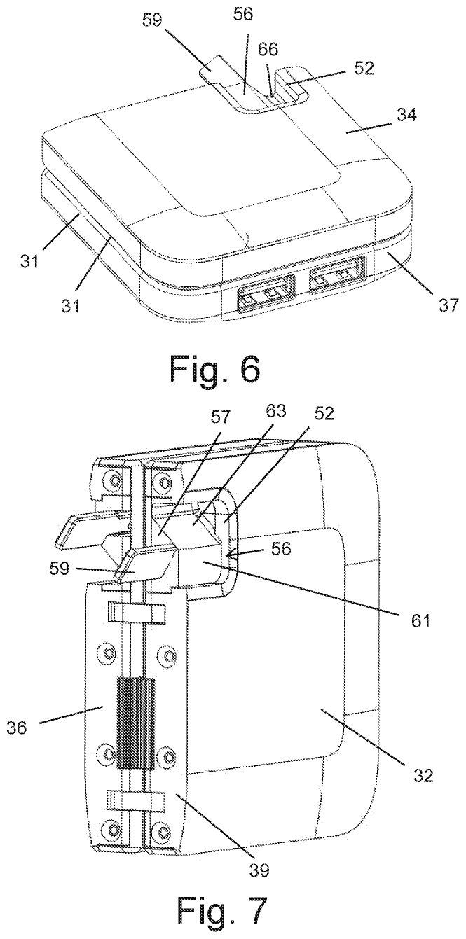

Charger 40 is configured with a set of hinges 42 interconnecting first charger body section 34 and second charger body section 37 according to any means well known to those skilled in the art, while a thickened hinge portion 43 passes through an opening 33 formed in inner faces 36 and 39 of sections 34 and 37, respectively, as shown in FIGS. 4 and 5. Two hinges 42 are shown, but any other suitable number of hinges may be employed. Each of the hinges 42 underlie the inner face of sections 34 and 37, which may be in abutting relation with each other when charger 40 is in the opened condition or positioned such that there is a slight interspace therebetween. The set of hinges 42 thus permit sections 34 and 37 to be inwardly folded until the bottom face 31 of sections 34 and 37 are in abutting relation with each other and inner faces 36 and 39 are contiguous to each other, as shown in FIGS. 6 and 7.

The inner faces are shown to be located at a central region of the charger, but sections 34 and 37 may be sized in any other fashion so that the relative position of the inner faces with respect to the charger in the opened condition, and the relative position of the flexible cable which passes through an internal charger region that is devoid of circuitry and through a continuous and common portion of the two sections, may correspondingly differ.

Charger 40 is schematically represented herein as having charger body sections 34 and 37 which appear to be separate sections, but in reality sections 34 and 37 have a continuous and common portion to accommodate the passage therethrough of the flexible cable.

End face 46 is provided with two USB ports 47 electrically connected in parallel to the second circuit, within each of which a mobile device is insertable and chargeable.

A top view of charger 40 in an opened condition is shown in FIG. 3. Each of first charger body section 34 and second charger body section 37 is formed with a recess 52, e.g. rectangular, which coincides with a corresponding inner face of the charger body section. The width of recess 52 is considerably less, approximately a third, of the width of the charger body section in which it is formed. The two recesses 52 are symmetrically formed, and are slightly spaced from the corresponding front face 38. The length of each recess 52, i.e. between the inner face and the end face, is approximately a third of the section length.

A prong bearing abutment block 56 is provided in each recess 52, such that the block within the recess of section 37 is positioned at the side thereof closest to front face 38 while the block within the recess of section 34 is positioned at the side thereof closest to rear face 41. Only one prong 59 is shown in FIG. 3 for purposes of clarity.

Block 56, which is illustrated more clearly in FIG. 7, extends lengthwise within recess 52 and is truncated at the inner face of the corresponding charger body section. Block 56 has an upper face 61 which is substantially parallel to the upper face 32 of the corresponding charger body section and an oblique face 63 which extends obliquely from upper face 61 to the floor 66 of recess 52, shown in FIG. 6. A prong 59 protrudes lengthwise from the truncated face 57. Prong 59 is shown to be angularly spaced from the block upper face 61, e.g. at an angle of 45 degrees, but may be substantially parallel to upper face 61 if so desired.

With reference to FIG. 5, oblique face 63 functions as an abutment for the angularly spaced prong 59. When charger 40 is set to the opened condition, prong 59 abuts oblique face 63 and is consequently prevented from being additionally angularly displaced.

When a disposition changing force is applied to one of the two charger body sections 34 and 37 set to the opened condition, the charger becomes inwardly folded and the two prongs 59 become separated from the corresponding abutment and are accessible. After the charger is set to the folded condition as shown in FIG. 7, the two prongs 59 which are connected to the first circuit are parallel to each other and are able to be plugged into the corresponding slots of a socket, in order to feed AC power to the charger. When the charger is used in a country having outlets with three slots, the prongs 59 may be coupled to an adapter having three prongs.

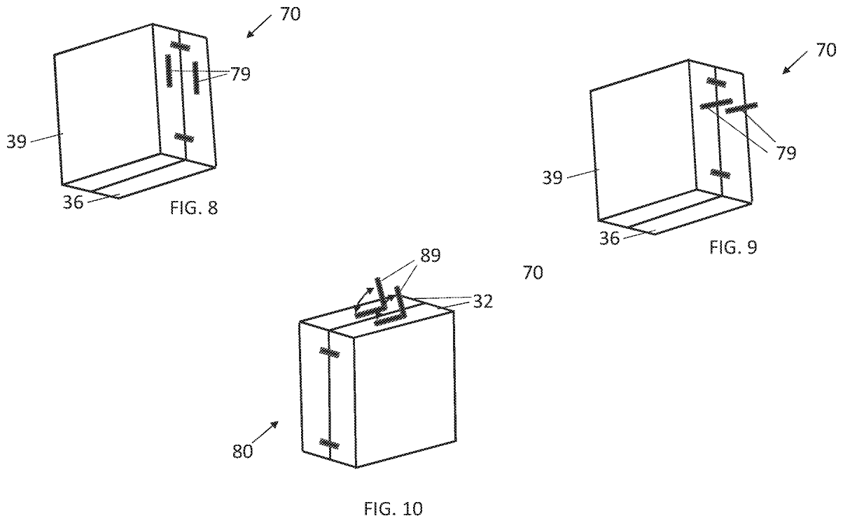

In another embodiment illustrated in FIGS. 8 and 9, charger 70 is configured with a prong 79 positioned at each inner face 36 and 39 thereof, and may be recessed therewithin. After charger 70 is set to the closed condition, prongs 79 are pivoted, to facilitate connection to the outlet.

FIG. 10 illustrates an embodiment of a charger 80 having two pivotable prongs 89 positioned on the upper face 32. When charger 80 is set to the closed position, the two prongs 89 are sufficiently close to each other to facilitate connection to an outlet.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A size adjustable AC-DC charger, comprising first and second charger body sections, and one or more force transmitting elements configured to be interconnected between said first and second charger body sections and to transmit a disposition changing force to said second charger body section after being applied to said first charger body section to facilitate a size adjustment operation, wherein said charger is operable to charge a powered device when said second charger body section is positioned at both a first disposition prior to said size adjustment operation and at a second disposition following said size adjustment operation.

2. The charger according to claim 1, comprising a first circuit connectable to a source of AC power and housed within the first body section, a second circuit connectable to also connectable to the source of AC power, and in charging relation with, the powered device and housed within the second body section, and a flexible cable extending between said first circuit and said second circuit to maintain current flow therebetween despite a change in disposition of the second charger body section.

3. The charger according to claim 2, wherein the flexible cable passes through an internal charger region that is devoid of circuitry and through a continuous and common portion of the first and second body sections.

4. The charger according to claim 1, which is foldable between an opened condition and a closed condition.

5. The charger according to claim 4, further comprising a set of outlet-connectable prongs that are inaccessible or inoperatively connectable to an outlet when the charger is set to the opened condition and that are accessible and operatively connectable to the outlet when the charger is set to the closed condition.

6. The charger according to claim 5, wherein each of the first and second charger body sections is formed with a recess coinciding with a corresponding inner face thereof and with a prong bearing block which is fixed within said recess configured such that one of the prongs extends lengthwise from said block and is inaccessibly received within the recess of the other charger body section when the charger is set to the opened condition, yet protrudes from the corresponding inner face when the charger is set to the closed condition.

7. The charger according to claim 4, wherein the prongs are pivotable so as to be accessible to the outlet in a first pivoted position and to be inaccessible to the outlet in a second pivoted position.

8. The charger according to claim 7, wherein each of the prongs is positioned on an inner face of the charger and is inaccessible to the outlet when the charger is set to the opened condition.

9. The charger according to claim 7, wherein each of the prongs is positioned on an upper or lower face of the charger and is inoperatively connectable to the outlet when the charger is set to the opened condition due to spacing between the prongs which is greater than spacing between slots of the outlet.

10. The charger according to claim 1, wherein the thickness of the charger in an opened condition is less than 1 cm.
